(19) United States
(12) Patent Application Publication
(10) Pub. No.: US 2020/0160349 A1
(43) Pub. Date: May 21, 2020

(54) BUSINESS DATA DRIVEN RESOURCE MANAGEMENT

(71) Applicant: Hitachi, Ltd., Tokyo (JP)

(72) Inventor: Satoshi Kaneko, Sunnyvale, CA (US)

(73) Assignee: Hitachi, Ltd.

(21) Appl. No.: 16/193,460

(22) Filed: Nov. 16, 2018

(51) Int. Cl. G06Q 30/00; G06Q 10/06

(52) U.S. Cl. CPC G06Q 30/016; G06Q 10/06316; G06Q 10/06315

(57) ABSTRACT

Example implementations described herein are directed to a management program that generates resource configuration plans to minimize loss cost and allocate high service level resources to business applications in response to service tickets requested by a service management server. Such example implementations involve utilizing business data, application data and resource data to prioritize existing service tickets and allocating Information Technology (IT) resources.

### BACKGROUND

### Field

The present disclosure is generally related to Information Technology (IT) resource management, and more specifically, for management of resources based on business data.

### Related Art

In related art implementations, there are systems and methods for management of IT resources within container systems, including multi-cloud systems. The use of supply chain economics alone and in combination with other techniques in the related art offers a unified platform to integrate, optimize or improve, and automate resource management in a container system. Such related art techniques may be used to monitor and control the delivery of service level agreements (SLA) and software licenses. Such related art implementations may also be used to monitor and control contention of computing resources in a container system, and to suspend or terminate computing resources.

### SUMMARY

However, related art implementations have a need for management systems that can create resource configuration plans and prioritizing existing service tickets or request based on a business value gained by applications.

Aspects of the present disclosure include a method, involving obtaining loss cost information from a business application server and applying the loss cost information on a plurality of service requests to calculate a loss cost for each of the plurality of service requests; prioritizing the plurality of service requests based on the loss cost calculation; and forwarding approved ones of the plurality of service requests to an information technology (IT) resource management server configured to reconfigure IT resources according to the service request.

Aspects of the present disclosure include a computer program having instructions involving obtaining loss cost information from a business application server and applying the loss cost information on a plurality of service requests to calculate a loss cost for each of the plurality of service requests; prioritizing the plurality of service requests based on the loss cost calculation; and forwarding approved ones of the plurality of service requests to an information technology (IT) resource management server configured to reconfigure IT resources according to the service request. The computer program may be stored on a non-transitory computer readable medium for execution by one or more processors.

Aspects of the present disclosure include a system, involving means for obtaining loss cost information from a business application server and applying the loss cost information on a plurality of service requests to calculate a loss cost for each of the plurality of service requests; means for prioritizing the plurality of service requests based on the loss cost calculation; and means for forwarding approved ones of the plurality of service requests to an information technology (IT) resource management server configured to reconfigure IT resources according to the service request.

Aspects of the present disclosure include a system, involving a processor configured to obtain loss cost information from a business application server and apply the loss cost information on a plurality of service requests to calculate a loss cost for each of the plurality of service requests; prioritize the plurality of service requests based on the loss cost calculation; and means for forwarding approved ones of the plurality of service requests to an information technology (IT) resource management server configured to reconfigure IT resources according to the service request.

Aspects of the present disclosure include a method, which involves obtaining loss cost information from a business application server and applying the loss cost information on a plurality of service requests to calculate a loss cost for each of the plurality of service requests; determining approved ones of the plurality of service requests having the loss cost calculation exceeding a threshold, for each of the approved ones of the plurality of service requests exceeding the threshold, creating a configuration plan for an IT resource management server to allocate IT resources designated as being high Service Level Agreement (SLA) resources to satisfy the loss cost; and forwarding the configuration plan for each of the approved ones of the plurality of service requests exceeding the threshold to the IT resource management server to reconfigure IT resources according to the configuration plan.

Aspects of the present disclosure include a computer program, which involves instructions for obtaining loss cost information from a business application server and applying the loss cost information on a plurality of service requests to calculate a loss cost for each of the plurality of service requests; determining approved ones of the plurality of service requests having the loss cost calculation exceeding a threshold, for each of the approved ones of the plurality of service requests exceeding the threshold, creating a configuration plan for an IT resource management server to allocate IT resources designated as being high Service Level Agreement (SLA) resources to satisfy the loss cost; and forwarding the configuration plan for each of the approved ones of the plurality of service requests exceeding the threshold to the IT resource management server to reconfigure IT resources according to the configuration plan. The computer program can be stored in a non-transitory computer readable medium storing instructions for execution by one or more processors.

Aspects of the present disclosure include a system, which involves means for obtaining loss cost information from a business application server and applying the loss cost information on a plurality of service requests to calculate a loss cost for each of the plurality of service requests; means for determining approved ones of the plurality of service requests having the loss cost calculation exceeding a threshold, for each of the approved ones of the plurality of service requests exceeding the threshold, means for creating a configuration plan for an IT resource management server to allocate IT resources designated as being high Service Level Agreement (SLA) resources to satisfy the loss cost; and means for forwarding the configuration plan for each of the approved ones of the plurality of service requests exceeding the threshold to the IT resource management server to reconfigure IT resources according to the configuration plan.

Aspects of the present disclosure include a system, which involves a processor, configured to obtain loss cost information from a business application server and apply the loss cost information on a plurality of service requests to calculate a loss cost for each of the plurality of service requests; determine approved ones of the plurality of service requests having the loss cost calculation exceeding a threshold, for each of the approved ones of the plurality of service requests exceeding the threshold, create a configuration plan for an IT resource management server to allocate IT resources designated as being high Service Level Agreement (SLA) resources to satisfy the loss cost; and forward the configuration plan for each of the approved ones of the plurality of service requests exceeding the threshold to the IT resource management server to reconfigure IT resources according to the configuration plan.

### BRIEF DESCRIPTION OF DRAWINGS

FIG. 1 illustrates a physical configuration of a system, in accordance with an example implementation.

FIG. 2 illustrates an example configuration of a management server, in accordance with an example implementation.

FIG. 3 illustrates an example business data table, in accordance with an example implementation.

FIG. 4 illustrates an application table, in accordance with an example implementation.

FIG. 5 illustrates a resource table, in accordance with an example implementation.

FIG. 6 illustrates a service ticket table, in accordance with an example implementation.

FIG. 7 illustrates an example flow diagram for the service hander program, in accordance with an example implementation.

FIG. 8 illustrates an example flow diagram directed to specifying resources which are used by business having a lower loss cost than the value, in accordance with an example implementation.

FIG. 9 illustrates an example flow diagram for the service handler program executed by the management server, in accordance with an example implementation.

FIG. 10 illustrates an example computing environment with an example computer device suitable for use in example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In an example implementation, there is a management program that creates a resource configuration plan to minimize loss cost and allocate high service level resource to important business application, in response to a service ticket which is requested via an IT Service Management Server. The management program utilize business data, application data and IT Resource data. Such example implementations provide examples as to how a management program prioritizes existing service tickets based on those data as well. Example of business applications can involve enterprise resource planning systems, sales/purchase systems, an others depending on the desired implementation.

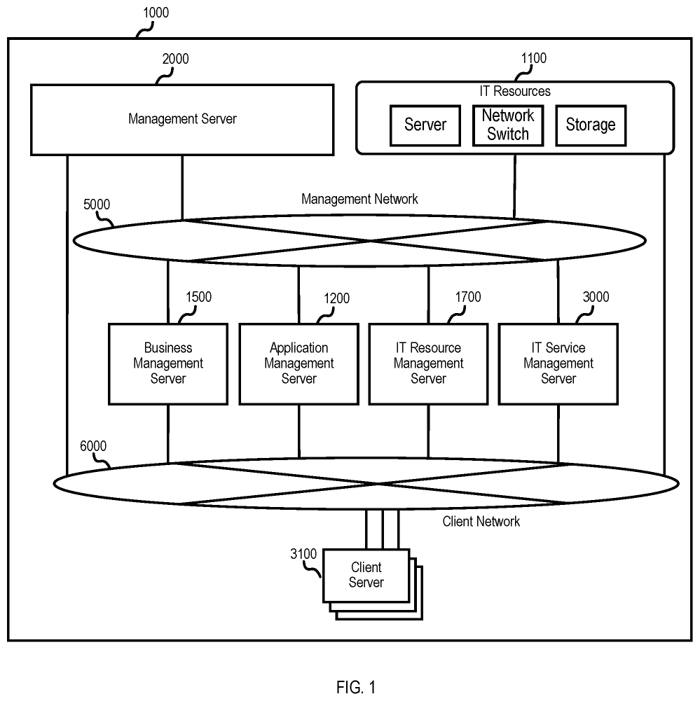

FIG. 1 illustrates a physical configuration of a system, in accordance with an example implementation. Specifically, FIG. 1 illustrates a physical configuration of the IT environment.

IT environment 1000 can involve a management server 2000, one or more client servers 3100, Business Management Server 1500, Application Management Server 1200, and IT Resources 1100, IT Resource Management Server 1700, and IT Service Management Server 3000, which are interconnected by management network 5000 and client network 6000.

IT Resources 1100 manages resources for the IT environment 1000, such as Server, Network Switch, Storage and so on according to the desired implementation. Client Servers 3100 are connected via Client network 6000. Such a network can be a LAN (Local Area Network) but it can be implemented in other ways in accordance with an example implementation.

Management server 2000, Business Management Server 1500, Application Management Server 1200, IT Resources Management Server 1700, IT Service Management Server 3000 and IT Resources 1100 are connected via management network 5000. Such a management network 5000 can be implemented as an LAN, but can also be implemented in other ways according to the desired implementation. Though management network 5000 and client network 6000 are separated in this example implementation, they can also be implemented as a single converged network.

In this example implementation, management server 2000, client servers 3100 Business Management Server 1500, Application Management Server 1200, IT Resource Management Server 1700, IT Service Management Server 3000 and IT Resources 1100 are separated; however, functions from any of such servers can be integrated in other servers depending on the desired implementation. For example, any server can host a management program.

Management Server 2000 creates a resource configuration plan to minimize the loss cost and allocate high service level resources to important business applications for a service ticket. The service ticket is requested via IT Service Management Server 3000 by using data such as: business data managed by Business Management Server 1500, application data managed by Application Management Server 1200, and IT Resource data managed by IT Resource Management Server 1700. Further, Management Server 2000 also prioritize existing service tickets based on such data in accordance with an example implementation.

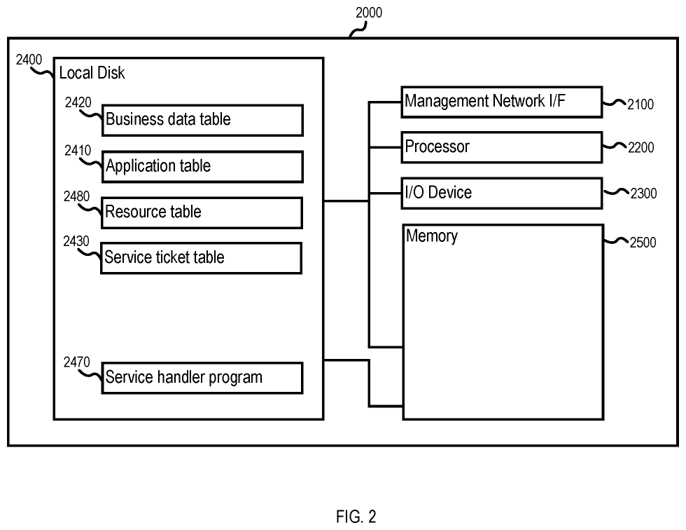

FIG. 2 illustrates an example configuration of a management server 2000, in accordance with an example implementation. Management Network Interface 2100 is an interface to connect the management server 2000 to the management network 5000. Input and output device 2300 is a user interface such as a monitor, a keyboard and a mouse, and/or other devices according to the desired implementation. Local Disk 2400 contains Business data table 2420, Application table 2410, Resource table 2440, Service ticket table 2430 and Service handler program 2470. Service handler Program 2470 is loaded to Memory 2500 and executed by processor 2200. Processor 2200 can be in the form of a physical hardware processor such as a central processing unit (CPU) and/or a combination of hardware and software processors to facilitate the desired implementation. The procedure of the Service handler program 2470 is disclosed below.

Business data table 2420, Application table 2410, Resource table 2440 and Service ticket table 2430 are loaded to Memory 2500 and used by the Service handler program 2470. Further description of such tables is provided below.

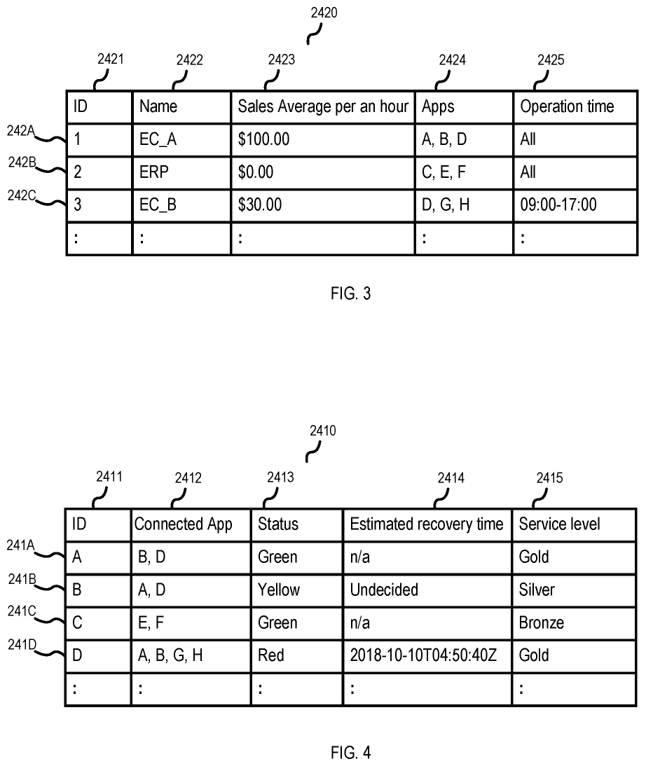

FIG. 3 illustrates an example business data table 2420, in accordance with an example implementation. The business data table involves business data which is managed by Business Management Server 1500. However, depending on the desired implementation, the table can also be created by Management Server 2000.

Column 2421 shows the identifier (ID) of the business implementation. Column 2422 shows a name of the business. Column 2423 shows the sales average per hour procured by the business implementation. Column 2424 shows application IDs involved in the business implementation. Column 2425 shows the operation time of the business implementation. Each row 242A, 242B, 242C shows the information pertaining to the business implementation. For example, row 242A shows that EC_A (e.g. Ecommerce application A) has an ID of 1 and procures roughly $100.00 in sales per hour, and EC_A involves application A, B, and D, and the operation time of EC_A is continuous at all times. In another example for row 242B, the sales average per hour column 2423 indicates that the procured sales is $0.00, which indicates that the business application enterprise resource planning (ERP) is not a commercial business implementation.

FIG. 4 illustrates an Application Table 2410, in accordance with an example implementation. This table involves application data managed by Application Management Server 1200. The application table 2410 includes data created by Service handler program 2470. Depending on the desired implementation, the table can be created by Management Server 2000, or by other servers depending on the desired implementation. Column 2411 shows the ID of the application. Column 2412 shows other applications that are connected to the application. Column 2413 shows a status of the application. Column 2414 shows an estimated recovery time of the application, if applicable. Column 2415 shows a service level of the application.

Each row 241A, 241B, 241C, 241D shows application information. For example, row 241A shows that application A connects to application B and D, and its status is Green. Green indicates that the application has no issues and is healthy. The service level of application A is Gold. In row 243C, status 2413 is Red which indicates an error state, and that the application will be recovered by 2018-10-1 OT04:50:40Z.

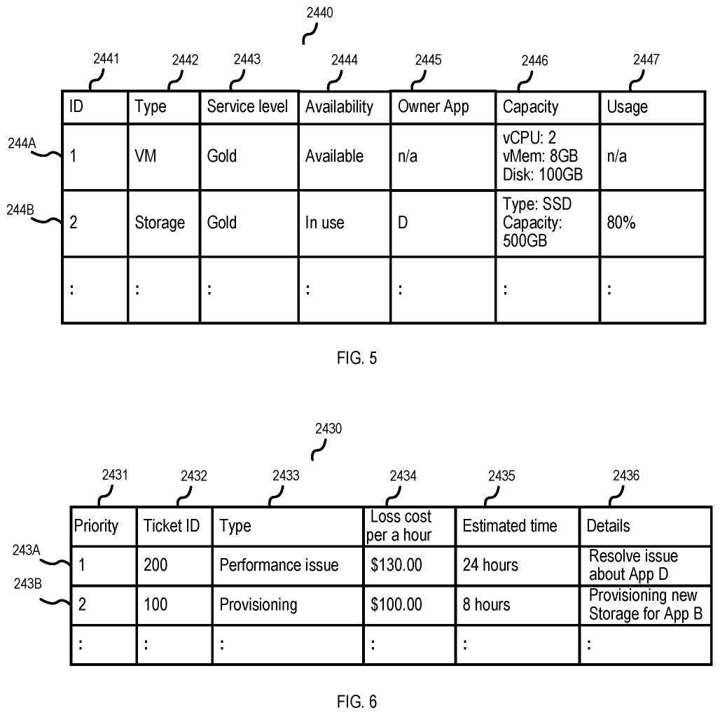

FIG. 5 illustrates a resource table 2440, in accordance with an example implementation. This table includes IT Resource data which are managed by IT Resource Management Server 1700. However, the resource table 2440 can be created by Management Server 2000 or by other servers in accordance with the desired implementation.

Column 2441 shows an ID of the resource. Column 2442 shows a type of the resource. Column 2443 shows a service level of the resource. Column 2444 shows an availability of the resource. Column 2445 shows an owner application ID of the resource. Column 2446 shows a capacity of the resource. Column 2447 shows a usage rate of the resource.

Each row 244A, 244B shows resource information. For example, row 244A shows that the service level of resource 1 is Gold and the resource type is Virtual Machine (VM). Further, row 244A indicates that resource 1 is not owned by any application, and the capacity includes 2 virtual CPUs (vCPU), 8 gigabytes (GB) of Virtual Memory, and 100 GB of local disk capacity.

In row 244B, resource 2 is used by application D, and its usage is 80%. The usage can refer to the capacity usage rate at the time it is measured, an average of the capacity usage rate for a specific period of time, or performance usage against to an available performance, or otherwise according to the desired implementation.

FIG. 6 illustrates a service ticket table 2430, in accordance with an example implementation. The table involves service ticket data which is managed by IT Service Management Server 3000. The service ticket is created by accepting a service request by end users of the IT service. Further, the table includes data which is created by Service handler program 2470.

This table can be created by Management Server 2000, or by other servers in accordance with the desired implementation.

Column 2431 shows a priority of the service ticket. Column 2432 shows an ID of the service ticket. Column 2433 shows a type of service request. Column 2434 shows the loss cost per hour that would occurs if the service request has not been completed. Column 2435 shows an estimated amount of time required to complete the service request. Column 2436 shows a detail of service request.

Each row 243A, 243B shows the service ticket information. For example, row 243B shows that service ticket 100 is prioritized as the second ticket of all service tickets. The type of the service request is provisioning and the detail is to provision new storage to application B. If the ticket has not been completed, it will cause $100.00 in loss costs per hour. Further, it will take eight hours to complete the service request.

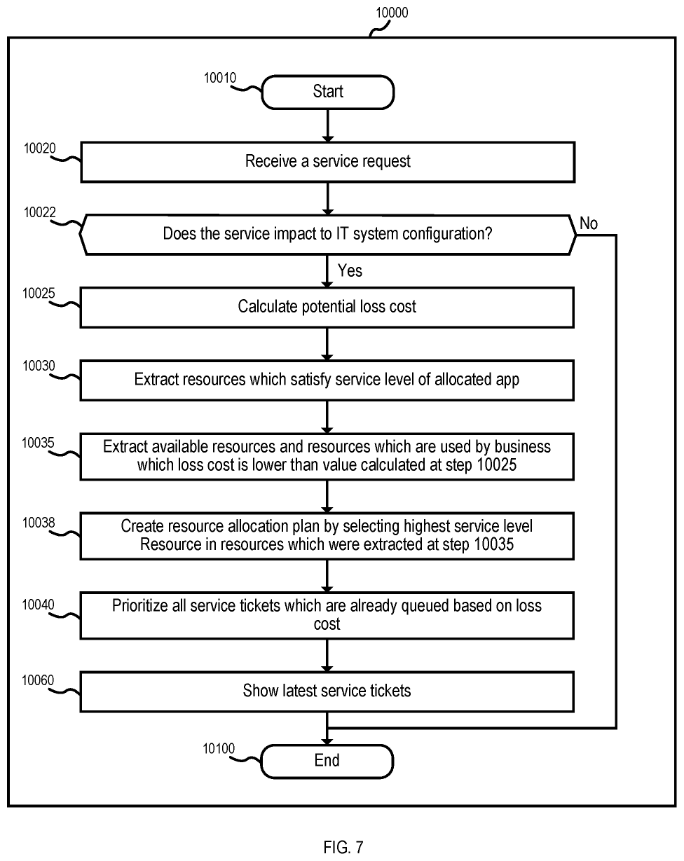

FIG. 7 illustrates an example flow diagram for the service handler program 2470, in accordance with an example implementation. Specifically, FIG. 7 illustrates a flowchart for creating a resource configuration plan to minimize the loss cost and allocate high service level resource to important business applications for a service ticket requested via IT Service Management Server 3000 by using business data, Application data and IT Resource data. Further, Service handler program 2470 also prioritizes existing service tickets based on those data as well.

At 10020, the flow begins by receiving a service request. The information of the service request includes service type (as shown in column 2433 in Service ticket table 2430) and its detail (as shown in column 2436 in Service ticket table 2430).

At 10022, the Service handler program 2470 determines whether the service impacts to the IT system configuration or not. The Service handler program 2470 determines the service impact based on a service type, but it is not limited thereto and can be conducted by any desired implementation. For example, row 243A in Service ticket table 2430 of FIG. 6 shows that the type of service request is “Provisioning”, which affects the IT system configuration. In this case, Service handler program 2470 determines the service request impacts to IT system configuration because “Provisioning” use IT resources to allocate it to the end user.

Thus, if the IT system configuration is affected (Yes), then the process proceeds to the flow at 10025. Otherwise (No), the flow proceeds to 10100.

At 10025, the Service handler program 2470 calculates the potential loss cost. At first, Service handler program 2470 specifies the business which is related to the service request. In the example of row 243A in Service ticket table 2430 of FIG. 6, the service request impacts Business 1 in row 242A from Business data table 2420 of FIG. 3 based on column 2436 in row 243A in Service ticket table 2430 of FIG. 6.

In the example of row 243B in Service ticket table 2430 of FIG. 6, the service request impacts Business 1 in row 242A and Business 3 in row 242C because column 2436, row 243B in Service ticket table 2430 of FIG. 6 indicates that the service ticket impacts Application D, and Application D is used by Business 1 and Business 3 based on column 2424 in Business data table 2420.

After specifying the impacted business, the Service handler program 2470 calculates the potential loss cost for each business by using data in column 2423 in Business data table 2420 and estimated time to complete the service request. The calculation of the loss cost is based on determining the business applications executed on the business application server associated with the each of the plurality of service requests; determining affected business systems associated with the business applications; and calculating the loss cost for the each of the plurality of service requests by aggregating a loss cost of each of the affected business systems based on an estimated time to complete the each of the plurality of service requests as described below.

The estimated time to complete the service request can be automatically determined by service handler program 2470 based on past data involving the same type service ticket, and also be specified by IT Operator via I/O device 2300 manually, or by any other desired implementation. Hence, the potential loss cost can be calculated as follows:

(Sum of loss cost per an hour of impacted business)*(Estimated time to complete service request)

In the example of row 243A in Service ticket table 2430 of FIG. 6, the potential loss cost can be calculated as below.

($100.00+$30.00)*24.0=$3120.00

Then, Service handler program 2470 updates Service ticket table 2430.

At 10030, the Service handler program 2470 extract resources which satisfy a service level of the allocated application as indicated in column 2415 in Application table 2410 of FIG. 4.

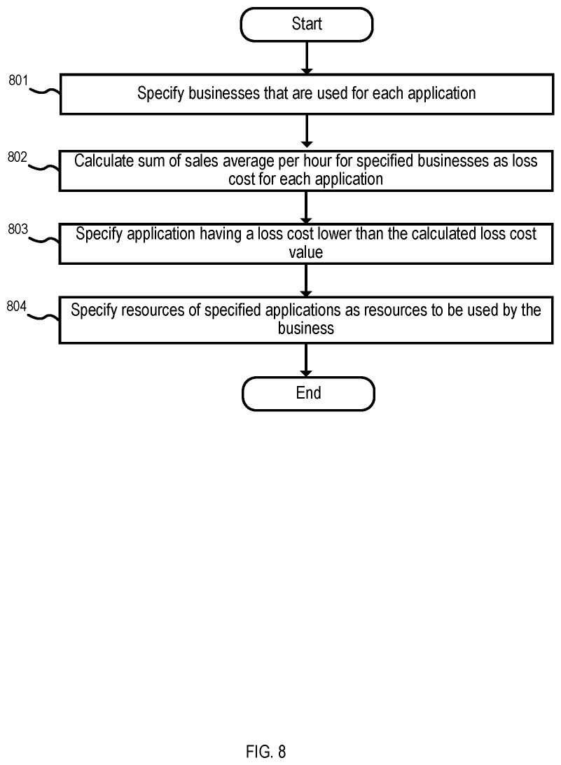

At 10035, the Service handler program 2470 extract available resources and resources utilized by business implementations having a lower loss cost than the value calculated at the flow of 10025. Service handler program 2470 extracts available resources based on column 2444 in Resource table 2440 of FIG. 5. Service handler program 2470 specifies resources which are used by business having a lower loss cost than the value calculated at the flow of 10025 as determined by the flow of FIG. 8.

At 10038, Service handler program 2470 creates resource allocation plans by selecting the highest service level resource in resources which were extracted at the flow of 10035.

If the selected resource is in use, the Service handler program 2470 can decide not to use the selected resource based on the impact of the configuration change, or through other implementations as desired.

At 10040, the Service handler program 2470 prioritizes all service tickets which are already queued based on loss cost, based on sorting the service tickets in order of loss cost. The loss cost of existing service requests in Service ticket table 2430 is calculated by the multiplication of column 2434 and column 2435 in Service ticket table 2430 of FIG. 6.

At 10060, the Service handler program 2470 shows latest service tickets to the operator based on the results from the flow of 10040 via I/O Device 2300.

At 10100, the Service handler program 2470 exits the process.

FIG. 8 illustrates an example flow diagram directed to specifying resources which are used by business having a lower loss cost than the value, in accordance with an example implementation. At 801, the Service hander program 2470 determines the businesses that are used by each application by referring to the information of FIG. 3. At 802, the Service hander program 2470 calculates the sum of the sales average per hour for the associated businesses as the loss cost for each application. That is, the Service hander program 2470 will traverse the information of FIG. 3 to identify the business implementations affected by the application, aggregate the product of the sales average per hour column 2423 with the operation time 2425 for each of affected businesses, and then determine a sales average per hour from the aggregation.

At 803, the Service hander program 2470 specifies applications for which the loss cost is lower than value calculated at step 10025 by comparing the loss cost for the specified loss cost for each application with the calculated loss cost. The applications having a lower loss cost than the loss cost calculated at step 10025 are identified as having potential resources that can be allocated for the service ticket request.

At 804, the Service hander program 2470 specifies the resources of the applications as available resources for resolving the service ticket request, as they are utilized by businesses having a lower loss cost than the loss cost calculated at step 10025.

Through the example implementations described herein, a management program creates a resource configuration plan to minimize loss cost and allocate high service level resources to important business applications for a service ticket requested via the IT Service Management Server by using business data, application data and IT Resource data. Further, the management program prioritizes existing service tickets based on such data in accordance with a desired implementation.

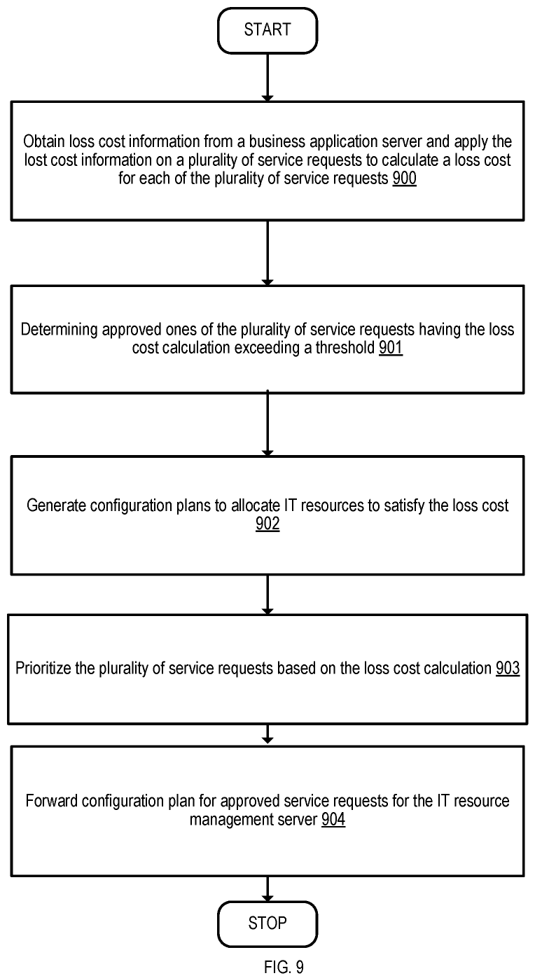

FIG. 9 illustrates an example flow diagram for the service handler program executed by the management server, in accordance with an example implementation. Specifically, FIG. 9 illustrates an example flow regarding the interactions between the management servers and the other servers. At 900, the service handler program obtains loss cost information from a business application server and applies the loss cost information on a plurality of service requests to calculate a loss cost for each of the plurality of service requests through obtaining information as indicated in FIG. 3 and using the flow of FIG. 8 to calculate the loss cost of each of the service requests.

At 901, the service handler program determines the approved ones of the plurality of service requests having the loss cost calculation exceeding a threshold. For example, some of the service requests do not require to be addressed by the service handler program as they do not result in a loss cost (e.g., request to IT department for new security access, request for password reset, etc.) and can be handled by other processes. Further some service requests can be filtered based on not incurring loss costs that meet a threshold, depending on the desired implementation. The threshold can be set any given value including zero. When the threshold is zero, the service handler program determines whether the service request is related to IT systems or not, and extract only service systems related to IT systems.

At 902, the service handler program generates configuration plans to allocate IT resources to satisfy the loss cost. For example, for each of the approved ones of the plurality of service requests exceeding the threshold, the service program handler can create a configuration plan for an IT resource management server to allocate IT resources designated as having high Service Level Agreement (SLA) resources or SLA resources that meet or exceed the requirements of the service request to satisfy the loss cost.

At 903, the service handler program prioritizes the plurality of service requests based on the loss cost calculation as illustrated in FIG. 6. Such prioritization can include sorting the service requests by total loss cost to be incurred, or by highest loss cost per hour, or otherwise depending on the desired implementation.

At 904, the service handler program forwards the configuration plans and/or the approved service requests to the IT resource management server, wherein the IT resource management server reconfigures IT resources according to the approved configuration plans and/or service requests. wherein the IT resource management server is configured to reconfigure IT resources by prioritizing available resources for allocation to the approved ones of the plurality of service requests, and then prioritizing allocated resources associated with business applications having a lower loss cost than the loss cost of the approved ones of the plurality of service requests.

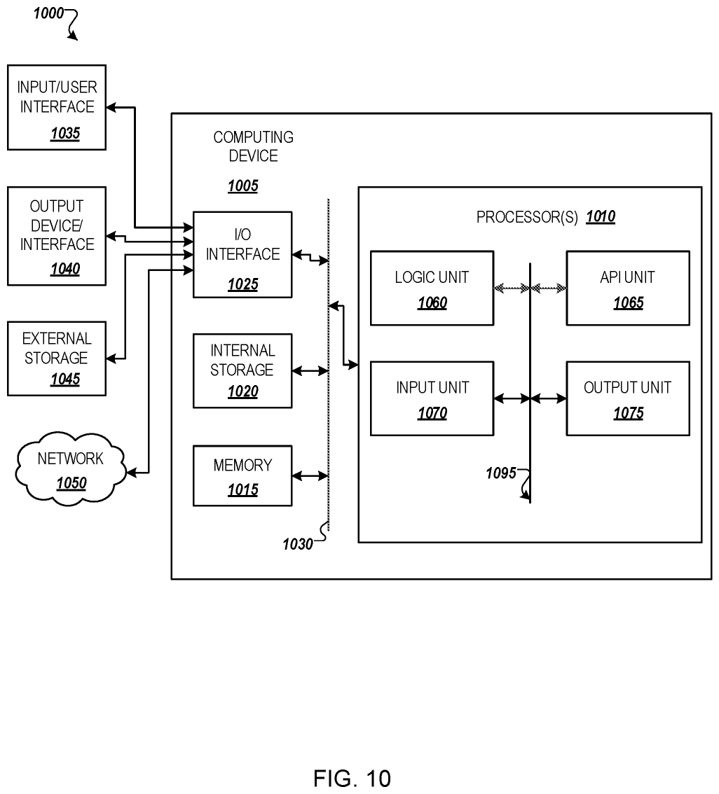

FIG. 10 illustrates an example computing environment with an example computer device suitable for use in example implementations, such as a business management server 1500, application management server 1200, IT resource management server 1700, and/or IT service management server 3000. Computer device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and/or I/O interface 1025, any of which can be coupled on a communication mechanism or bus 1030 for communicating information or embedded in the computer device 1005.

Computer device 1005 can be communicatively coupled to input/user interface 1035 and output device/interface 1040. Either one or both of input/user interface 1035 and output device/interface 1040 can be a wired or wireless interface and can be detachable. Input/user interface 1035 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1040 may include a display, television, monitor, printer, speaker, braille, or the like. In some example implementations, input/user interface 1035 and output device/interface 1040 can be embedded with or physically coupled to the computer device 1005. In other example implementations, other computer devices may function as or provide the functions of input/user interface 1035 and output device/interface 1040 for a computer device 1005. In example implementations involving a touch screen display, a television display, or any other form of display, the display is configured to provide a user interface.

Examples of computer device 1005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1005 can be communicatively coupled (e.g., via I/O interface 1025) to external storage 1045 and network 1050 for communicating with any number of networked components, devices, and systems, including one or more computer devices of the same or different configuration. Computer device 1005 or any connected computer device can be functioning as, providing services of, or referred to as a server, client, thin server, general machine, special-purpose machine, or another label.

I/O interface 1025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computer device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Memory 1015 may be configured to store or manage algorithms to be executed by processor(s) 1010 as described in the flow, for example, of FIGS. 7 to 9, along with the data to be processed from FIGS. 3 to 6 to facilitate the example implementations described herein. The example implementations as described herein may be conducted singularly, or in any combination of each other according to the desired implementation and are not limited to a particular example implementation.

Processor(s) 1010 can execute under any operating system (OS) (not shown), in a native or virtual environment. One or more applications can be deployed that include logic unit 1060, application programming interface (API) unit 1065, input unit 1070, output unit 1075, and inter-unit communication mechanism 1095 for the different units to communicate with each other, with the OS, and with other applications (not shown). The described units and elements can be varied in design, function, configuration, or implementation and are not limited to the descriptions provided. Processor(s) 1010 can be in the form of physical processors or central processing units (CPU) that is configured to execute instructions loaded from Memory 1015.

In some example implementations, when information or an execution instruction is received by API unit 1065, it may be communicated to one or more other units (e.g., logic unit 1060, input unit 1070, output unit 1075). In some instances, logic unit 1060 may be configured to control the information flow among the units and direct the services provided by API unit 1065, input unit 1070, output unit 1075, in some example implementations described above. For example, the flow of one or more processes or implementations may be controlled by logic unit 1060 alone or in conjunction with API unit 1065. The input unit 1070 may be configured to obtain input for the calculations described in the example implementations, and the output unit 1075 may be configured to provide output based on the calculations described in example implementations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
obtaining loss cost information from a business application server and applying the loss cost information on a plurality of service requests to calculate a loss cost for each of the plurality of service requests;
prioritizing the plurality of service requests based on the loss cost calculation; and
forwarding approved ones of the plurality of service requests to an information technology (IT) resource management server configured to reconfigure IT resources according to the service request.

2. The method of claim 1, wherein the forwarding approved ones of the plurality of service requests comprises:
determining the approved ones of the plurality of service requests having the loss cost calculation exceeding a threshold,
for each of the approved ones of the plurality of service requests exceeding the threshold, creating a configuration plan for the IT resource management server to allocate IT resources designated as being high Service Level Agreement (SLA) resources to satisfy the loss cost.

3. The method of claim 1, wherein the IT resource management server is configured to reconfigure IT resources by prioritizing available resources for allocation to the approved ones of the plurality of service requests, and then prioritizing allocated resources associated with business applications having a lower loss cost than the loss cost of the approved ones of the plurality of service requests.

4. The method of claim 1, wherein the IT resource management server is configured to allocate IT resources having a service level agreement (SLA) that meets or exceeds the SLA of the approved ones of the plurality of service requests.

5. The method of claim 1, wherein the calculation of the loss cost for each of the plurality of service requests is conducted by, for each of the plurality of service requests:
determining business applications executed on the business application server associated with the each of the plurality of service requests;
determining affected business systems associated with the business applications; and
calculating the loss cost for the each of the plurality of service requests by aggregating a loss cost of each of the affected business systems based on an estimated time to complete the each of the plurality of service requests.

6. A method, comprising:
obtaining loss cost information from a business application server and applying the loss cost information on a plurality of service requests to calculate a loss cost for each of the plurality of service requests;
determining approved ones of the plurality of service requests having the loss cost calculation exceeding a threshold,
for each of the approved ones of the plurality of service requests exceeding the threshold, creating a configuration plan for an IT resource management server to allocate IT resources designated as being high Service Level Agreement (SLA) resources to satisfy the loss cost; and
forwarding the configuration plan for each of the approved ones of the plurality of service requests exceeding the threshold to the IT resource management server to reconfigure IT resources according to the configuration plan.

7. The method of claim 6, further comprising prioritizing the plurality of service requests based on the loss cost calculation.

8. The method of claim 6, wherein the IT resource management server is configured to reconfigure IT resources by prioritizing available resources for allocation to the approved ones of the plurality of service requests, and then prioritizing allocated resources associated with business applications having a lower loss cost than the loss cost of the approved ones of the plurality of service requests.

9. The method of claim 6, wherein the IT resource management server is configured to allocate IT resources having a service level agreement (SLA) that meets or exceeds the SLA of the approved ones of the plurality of service requests.

10. The method of claim 6, wherein the calculation of the loss cost for each of the plurality of service requests is conducted by, for each of the plurality of service requests:
determining business applications executed on the business application server associated with the each of the plurality of service requests;
determining affected business systems associated with the business applications; and
calculating the loss cost for the each of the plurality of service requests by aggregating a loss cost of each of the affected business systems based on an estimated time to complete the each of the plurality of service requests.

11. A non-transitory computer readable medium, storing instructions for executing a process, the instructions comprising:
obtaining loss cost information from a business application server and applying the loss cost information on a plurality of service requests to calculate a loss cost for each of the plurality of service requests;
prioritizing the plurality of service requests based on the loss cost calculation; and
forwarding approved ones of the plurality of service requests to an information technology (IT) resource management server configured to reconfigure IT resources according to the service request.

12. The non-transitory computer readable medium of claim 11, wherein the forwarding approved ones of the plurality of service requests comprises:
determining the approved ones of the plurality of service requests having the loss cost calculation exceeding a threshold,
for each of the approved ones of the plurality of service requests exceeding the threshold, creating a configuration plan for the IT resource management server to allocate IT resources designated as being high Service Level Agreement (SLA) resources to satisfy the loss cost.

13. The non-transitory computer readable medium of claim 11, wherein the IT resource management server is configured to reconfigure IT resources by prioritizing available resources for allocation to the approved ones of the plurality of service requests, and then prioritizing allocated resources associated with business applications having a lower loss cost than the loss cost of the approved ones of the plurality of service requests.

14. The non-transitory computer readable medium of claim 11, wherein the IT resource management server is configured to allocate IT resources having a service level agreement (SLA) that meets or exceeds the SLA of the approved ones of the plurality of service requests.

15. The non-transitory computer readable medium of claim 11, wherein the calculation of the loss cost for each of the plurality of service requests is conducted by, for each of the plurality of service requests:
determining business applications executed on the business application server associated with the each of the plurality of service requests;
determining affected business systems associated with the business applications; and
calculating the loss cost for the each of the plurality of service requests by aggregating a loss cost of each of the affected business systems based on an estimated time to complete the each of the plurality of service requests.
